(19) United States
(12) Patent Application Publication
(10) Pub. No.: US 2009/0299985 A1
(43) Pub. Date: Dec. 3, 2009

(54) Network Based Address Book with Optional Storage of Data

(75) Inventors: Christer Boberg, Tungelsta (SE); Mikael Klein, Huddinge (SE); Anders Lindgren, Alvsjo (SE)

Correspondence Address: POTOMAC PATENT GROUP PLLC, P. O. BOX 270, FREDERICKSBURG, VA, 22404, US

(73) Assignee: Telefonaktiebolaget LM Ericsson (publ), Stockholm (SE)

(21) Appl. No.: 12/127,423

(22) Filed: May 27, 2008

(51) Int. Cl. G06F 7/06; G06F 17/30; G06F 15/16

(52) U.S. Cl. 707/4; 709/202; 707/E17.014

(57) ABSTRACT

A system, server, computer readable medium and method for receiving personal information about a first user and providing the personal information to a second user, where the first and second users are connected to corresponding first and second servers in a communication network. The method includes receiving at the second server, from the second user, a request for the personal information of the first user, accessing an address of the first user based on an address book of the second user, wherein the address book of the second user is accessible to the second server, contacting the first server based on the address of the first user and requesting from the first server the personal information of the first user, receiving the personal information of the first user from the first server, and providing the received personal information of the first user to the second user, without storing the received personal information in the second server or in an associated storage device.

### TECHNICAL FIELD

The present invention generally relates to systems, devices, software and methods and, more particularly, to mechanisms and techniques for reducing a size of a network based address book.

### BACKGROUND

With the advancement of Internet, mobile telephony, and miniature electronic devices, which are able to use both the Internet and mobile telephony, the end-users want to enjoy new communication services, which can be accessed any time, anywhere, on any device, independent of the access network. The end-users expect services that support their mobility at home, on travel, and on business such as one-network based address book. The end-users want to use different end-devices, and they expect service profiles tailored at the end-devices capabilities. Service profiles enable the users to switch easily between their private and business roles, i.e., from one device used at home to another device used for business. Moreover, the end-users need devices, which support the services and enable easy and comfortable subscriber self-administration. The network based address book is an example of such a service.

A single network based address book is desirable because the users are dealing presently with many address books (such as device resident, SIM resident, service dependent and ISP offered) that cause difficult and bad user experiences. All address books have to be manually synchronized and they seem to be always out of sync.

Therefore, it is an advantage to have the address information stored on a server that may be easily accessed by mobile and fixed end-devices. For this kind of service, the clients' devices have to support the network address book and the network address book has to support the clients' devices. Thus, the network address book allows a single user to have multiple devices, not identical, and to change the address book with one device and use the updated address book with another device without worrying about synchronizing the different devices.

Further, the existing address books do not provide any network to network interface in which a user can subscribe to or fetch personal card information from another user. Thus, the user populates his address book using information that is obtained from different places, for example, from business cards. Therefore, the whole task of populating the address book is difficult.

In the Open Mobile Alliance standardization work, this last problem is addressed and it is expected that a user will subscribe/fetch information about other users' personal data via the network, based on the network based address book.

The network based address book may be implemented in a server, for example, so that the user has its address book stored in the network. Thus, the personal data provided by a user “A” is copied in many places of the network, as each authorized contact “B” retrieves the personal data of user A and stores it in a corresponding location. Even more, not only users B that are authorized by user A but any user that at any time in the past has been authorized or, by other means, has obtained the personal data of user A may store the personal data of user A in the network. Thus, the amount of data stored in the network is huge, as the personal card data for each user A is stored both in the personal card server of user A as well as in the network based address book of user B, which is one of the contacts of user A.

This situation is illustrated in FIG. 1, in which users X1 to Xn are considered to store their personal card data in a corresponding personal card server 10 and users X1 to Xn are contacts of users A1 to An. The personal card server 10 may store the personal card data of users X1 to Xn in a personal card storage device 12. Users A1 to An may share a server 14 that maintains the network based address book (NAB) and this NAB server 14 may include contacts and personal card data storage device 16. NAB 14 may communicate with the personal card server 12. The personal card information of a user may include, besides the address of the user, a picture, video or any data determined by the user.

For a user An to receive the personal data of a user X1 the following steps are performed. In step 1, one or more of users X1 to Xn send the personal card data to the personal card server 10. In step 2, the personal card server 10 stores the data received from the users in the personal cards storing device 12. In step 3, one or more of the users A1 to An send contact information to NAB 14. In the same step or in a different step, the users A1 to An may send to NAB 14 a request to subscribe to the personal card data of one or more of users X1 to Xn. In step 4, NAB 14 stores the contacts in the address book. In step 5, NAB 14 fetches the personal card data of users X1 to Xn from the personal card server 10, in step 6 NAB 14 stores that data in the contacts and personal card data storage device 16, and in step 7 NAB 14 notifies one or more of users A1 to An about the received data.

Thus, according to this mechanism, the personal card data of one or all users X1 to Xn is stored in the personal card server 10 and also in the contacts and personal card data storing device 16 or NAB 14. A problem of this arrangement is not the non authorized users but the ones that are authorized as will be discussed next. Because the stored data may be large (in the order of megabytes) and the number of authorized contacts may be large (in the order of hundreds), the amount of data that is duplicated (in servers 10 and 14) is even larger. For example, the amount of storage necessary in the existing systems may be in the order of 100 000 000 MByte, given that the number of users may be one million, the size of the personal card data may be around 1 MByte, and the number of contacts in a typical address book may be 100.

One reason for duplicating this data is the fact that the address book information is personal and availability of this data is determined by the owner Ai of the address book and not by the user to whom the data concerns, i.e., the personal card owner Xi. However, in some cases, this statement is incorrect and the actual access to the information should be controlled by the personal card owner.

Accordingly, it would be desirable to provide devices, systems and methods for communication devices that avoid the afore-described problems and drawbacks.

### SUMMARY

The following exemplary embodiments provide a number of advantages and benefits relative to existing address book systems, devices and methods including, for example, the possibility to reduce the size of network address books and avoid duplication of personal card data in networks. It will be appreciated by those skilled in the art, however, that the claims are not limited to those embodiments which produce any or all of these advantages or benefits and that other advantages and benefits may be realized depending upon the particular implementation.

According to an exemplary embodiment, there is a method for receiving personal information about a first user and providing the personal information to a second user, wherein the first and second users are connected to corresponding first and second servers in a communication network. The method includes, receiving at the second server, from the second user, a request for the personal information of the first user; accessing an address of the first user based on an address book of the second user, wherein the address book of the second user is accessible to the second server; contacting the first server based on the address of the first user and requesting from the first server the personal information of the first user; receiving the personal information of the first user from the first server; and providing the received personal information of the first user to the second user, without storing the received personal information in the second server or in an associated storage device.

According to another exemplary embodiment, there is a receiving server for receiving personal information about a presentity and providing the personal information to a watcher, wherein the presentity and the watcher are connected to the receiving server and a sending server in a communication network. The receiving server includes a receiving port configured to receive from the watcher a request for the personal information of the presentity; a processor connected to the receiving port and configured to access an address of the presentity based on an address book of the watcher, wherein the address book of the watcher is accessible to the receiving server, configured to contact the sending server based on the address of the presentity and to request from the sending server the personal information of the presentity; the receiving port being further configured to receive the personal information of the presentity from the sending server; and the processor being further configured to provide the received personal information of the presentity to the watcher, without storing the received personal information.

According to another exemplary embodiment, there is a computer readable medium including computer executable instructions, wherein the instructions, when executed by a processor of a receiving server, cause the receiving server to receive personal information about a presentity and provides the personal information to a watcher, wherein the presentity and the watcher are connected to corresponding serving and receiving servers in a communication network. The instructions include receiving at the receiving server, from the watcher, a request for the personal information of the presentity; accessing an address of the presentity based on an address book of the watcher, wherein the address book of the watcher is accessible to the receiving server; contacting the sending server based on the address of the presentity and requesting from the sending server the personal information of the presentity; receiving the personal information of the presentity from the sending server; and providing the received personal information of the presentity to the watcher, without storing the received personal information in the receiving server or in an associated storage device.

According to still another exemplary embodiment, there is a method for fetching personal information about a first user and providing the personal information to a second user, wherein the first and second users are connected to a server in a communication network. The method includes storing in a first part of the server the personal information of the first user; storing in a second part of the server an address book of the second user; receiving at the second part of the server, from the second user, a request for the personal information of the first user; accessing in the second part of the server an address of the first user based on the address book of the second user, wherein the address book of the second user is accessible to the second part of the server; contacting the first part of the server based on the address of the first user and requesting from the first part of the server the personal information of the first user; receiving at the second part of the server the personal information of the first user from the first part of the server; and providing the received personal information of the first user to the second user, without storing the received personal information in the second part of the server.

According to yet another exemplary embodiment, there is a system for fetching personal information about a first user and providing the personal information to a second user, wherein the first and second users are connected to a server in a communication network. The system includes a first storage device in a first part of the server configured to store the personal information of the first user; a second storage device in a second part of the server configured to store an address book of the second user; a receiving port connected to the first and second parts of the server and configured to receive from the second user, a request for the personal information of the first user; a processor in the second part of the server connected to the receiving port and configured to access an address of the first user based on the address book of the second user, wherein the address book of the second user is accessible to the processor and to request from a processor of the first part of the server the personal information of the first user; the processor of the first part of the server providing to the processor of the second part of the server the personal information of the first user; and the processor of the second part of the server providing the received personal information of the first user to the second user, without storing the received personal information in the second storage device.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a conventional communication system including a network based address book server and users;

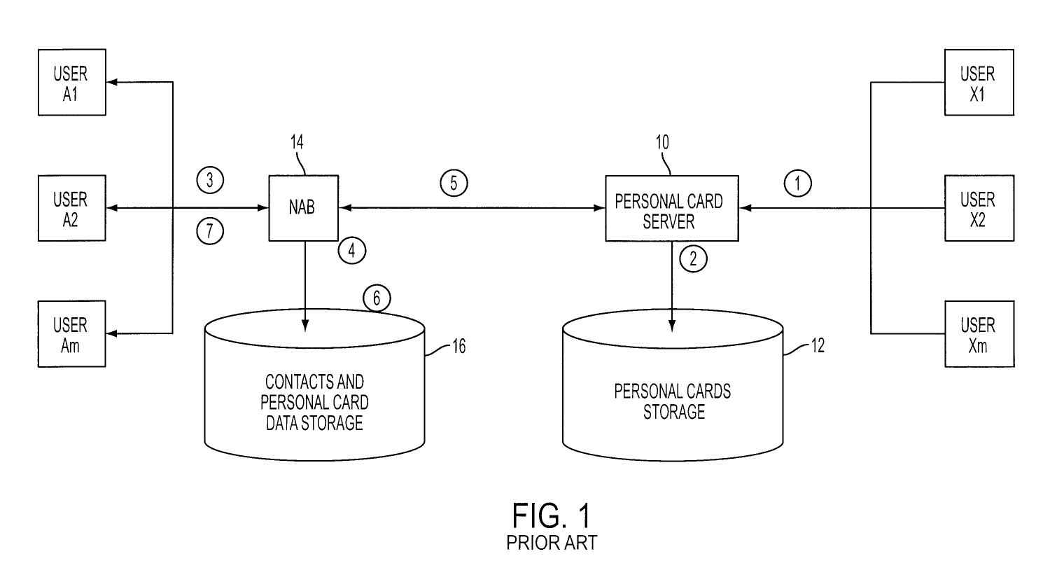

FIG. 2 is a schematic diagram of a communication system including a network based address book server and users according to an exemplary embodiment;

FIG. 3 is a diagram showing commands exchanged by the servers and users for retrieving personal information according to an exemplary embodiment;

FIG. 4 is a diagram showing commands exchanged by the servers and users for retrieving denied personal information according to an exemplary embodiment;

FIG. 5 is a flow diagram illustrating steps performed by the network based address book server according to an exemplary embodiment;

FIG. 6 is a flow diagram illustrating steps performed by a system according to an exemplary embodiment;

FIG. 7 is a schematic diagram of a device used by a user according to an exemplary embodiment; and

FIG. 8 is a schematic diagram of a server according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of presence systems described below. However, the embodiments to be discussed next are not limited to these systems but may be applied to other existing communication systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

In order to prevent unnecessary duplication of data and to provide a network to network service in which a user is capable of fetching or subscribing to personal card information of another user, according to an exemplary embodiment, the owner of the personal card information (the presentity) stores his personal data in the network for his authorized contacts (the watchers) to be accessed whenever needed. The notions of presentity and watchers are explained later. This exemplary embodiment does not prevent duplicative storage in the network as the users are free to store any kind of information. However, according to this exemplary embodiment, there is no need for the system/watcher to store the personal card information of the presentities. Further, according to another exemplary embodiment, the watchers may store additional data about a contact that is not provided by the presentity, such as a different picture than the one provided by the presentity.

The notion of “presence” and associated concepts are standardized by Internet Engineering Task Force (IETF) and the standardization specifications, the entire content of which are incorporated by reference herein, may be found at http://www.ietf.org/html.charters/simple-charter.html. In the following, an introduction to the presence system is provided. A number of entities may be implemented in a presence service architecture. One of these entities is the presentity, which is an entity that provides presence information. Another entity is the presence server, which receives presence information from presentities. The watcher is an entity that is interested in the presence information.

The presence information (e.g., location, willingness to communicate at a certain time or with certain users, etc.) may be collected and utilized by presence servers, which may notify authorized “watchers” who are interested in certain presence information. Watcher applications may be implemented in wireline and/or wireless terminals to obtain presence information from the presence servers about other users. This may come in the form of a notification, issued to the watcher by the presence server. The presence uses Session Initiation Protocol (SIP) as a presence protocol and uses a general event notification framework defined for SIP, and as such, makes use of the SUBSCRIBE and NOTIFY methods defined in the presence specifications.

An event package, which is introduced in the presence system and is defined in RFC 3265, is based on the concept of a presence agent, which is a new logical entity that is capable of accepting subscriptions, storing subscription state, and generating notifications when there are changes in presence. The entity is defined as a logical one, since it may be co-resident with another entity. A Presence User Agent (PUA) manipulates presence information for a presentity. This manipulation can be the side effect of some other action (such as using an XCAP PUT to add a new Contact) or can be performed explicitly through the publication of presence documents (e.g., using SIP PUBLISH). A user may have many devices (such as a cell phone and Personal Digital Assistant (PDA)), each of which is independently generating a component of the overall presence information for a presentity. PUAs push data into the presence system, but are outside of it, in that they do not receive SUBSCRIBE messages or send NOTIFY messages.

A presence agent (PA) is a SIP user agent which is capable of receiving SUBSCRIBE requests, responding to them, and generating notifications of changes in the presence state. A presence agent may have knowledge of the presence state of a presentity. This means that it has access to presence data manipulated by PUAs for the presentity. A PA is also a notifier (defined in RFC 3265) that supports the presence event package.

A presence server is a physical entity that may act as either a presence agent or as a proxy server for SUBSCRIBE requests. When acting as a PA, it is aware of the presence information of the presentity through some protocol means. When acting as a proxy, the SUBSCRIBE requests are proxied to another entity that may act as a PA. When an entity, the subscriber, wishes to learn about presence information from some other user, it creates a SUBSCRIBE request. The SUBSCRIBE request is carried along SIP proxies as other SIP requests. In most cases, it eventually arrives at a presence server, which may either generate a response to the request (in which case it acts as the presence agent for the presentity), or proxy it on to an edge presence server. If the edge presence server handles the subscription, it is acting as the presence agent for the presentity.

The presence agent (whether in the presence server or edge presence server) first authenticates the subscription, then authorizes it. If authorized, an OK response is returned. If authorization could not be obtained at this time, the subscription is considered “pending”, and another response is returned. In both cases, the PA sends an immediate NOTIFY message containing the state of the presentity and of the subscription. As the state of the presentity changes, the PA generates NOTIFYs containing those state changes to all subscribers with authorized subscriptions. Changes in the state of the subscription itself can also trigger NOTIFY requests; that state is carried in the Subscription-State header field of the NOTIFY, and would typically indicate whether the subscription is active or pending.

In many communications applications, such as Voice over IP, instant messaging, and presence, the network servers may access per-user information in the process of servicing a request. This per-user information may reside within the network, but may be managed by the end user themselves. Its management can be done through a multiplicity of access points, including the web, a wireless handset, or a PC application.

There are many examples of per-user information. One is presence authorization policy, which defines rules about which watchers are allowed to subscribe to a presentity, and what information they are allowed to access. Another is presence lists, which are lists of users whose presence is desired by a watcher. One way to obtain presence information for the list is to subscribe to a resource which represents that list. In this case, the Resource List Server (RLS) requires access to this list in order to process a SIP SUBSCRIBE request for it. Another way to obtain presence for the users on the list is for a watcher to subscribe to each user individually. In that case, it is convenient to have a server store the list, and when the client boots, it fetches the list from the server. This would allow a user to access their resource lists from different clients.

A protocol that may be used to manipulate this per-user data is described next. It is called the Extensible Markup Language (XML) Configuration Access Protocol (XCAP). XCAP is a set of conventions for mapping XML documents and document components into HTTP Uniform Resource Identifiers (URIs), rules for how the modification of one resource affects another, data validation constraints, and authorization policies associated with access to those resources. Because of this structure, normal HTTP primitives may be used to manipulate the data.

Each application (where an application refers to a use case that implies a collection of data and associated semantics) that makes use of XCAP specifies an application usage. This application usage defines the XML schema for the data used by the application, along with other pieces of information. One task of XCAP is to allow clients to read, write, modify, create and delete pieces of that data. An XCAP server acts as a repository for collections of XML documents. There may be documents stored for each application. Within each application, there are documents stored for each user. Each user may have a multiplicity of documents for a particular application. To access some component of one of those documents, XCAP defines an algorithm for constructing a URI that may be used to reference that component. Components refer to any element or attribute within the document. Thus, the HTTP URIs used by XCAP point to a document, or to pieces of information that are finer grained than the XML document itself. An HTTP resource which follows the naming conventions and validation constraints defined here is called an XCAP resource. Because XCAP resources are also HTTP resources, they can be accessed using HTTP methods. Reading an XCAP resource is accomplished with HTTP GET, creating or modifying one is done with HTTP PUT, and removing one of the resources is done with an HTTP DELETE. Having this presence background, a few exemplary embodiments, that may use the presence system and commands, are discussed next.

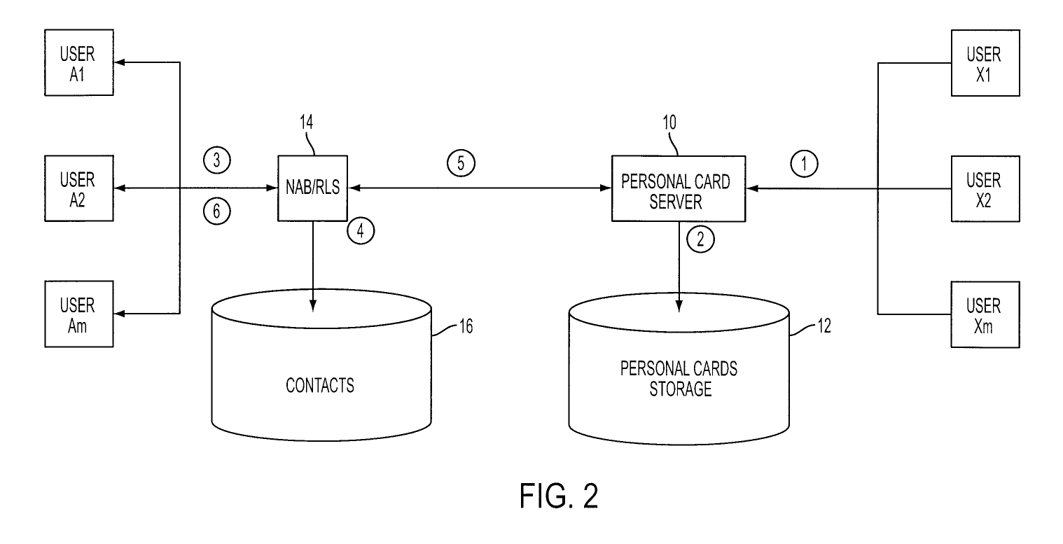

According to an exemplary embodiment shown in FIG. 2, NAB 14 is configured to not store the personal card data locally. The personal information of one or more users X1 to Xn may be shared by the devices of users A1 to An and the personal card server 10. Thus, according to this exemplary embodiment, NAB 14 acts as a subscription exploder. Although FIG. 2 shows that the RLS functionality is an integrated part of the network based address book, the RLS may be a separate entity that is not part of NAB 14 and NAB is just used for storage of information when needed.

More specifically, FIG. 2 shows that in step 1 one or more of users X1 to Xn send personal card data to the personal card server 10. The personal card server 10 may store in step 2 the data in the personal cards storage device 12. One or more of users A1 to An send in step 3 their contact data to NAB 14. In the same step or in a different step, the one or more users A1 to An may subscribe to personal card information of one or more users X1 to Xn. In step 4, NAB 14 may store the contact information to the contacts storing device 16. In step 5, NAB 14 retrieves/fetches the personal card information of one or more users X1 to Xn from server 10 and in step 6 the personal card information is sent to one or more users A1 to An. However, the personal card information retrieved in step 5 from one or more users X1 to Xn is not stored in the contacts storing device 16 or in any storage device associated with NAB 14.

This feature of not storing the retrieved personal card information does not prevent one or more users A1 to An from storing the personal card information either in their own storage devices or in a storage device associated with NAB 14. In other words, NAB 14 is capable of storing the personal card information of users X1 to Xn but is configured to not store such information unless specifically instructed by one of the users A1 to An.

The user Ai may subscribe to presence from its “buddies” and the presence data may include a link to the vCard information of the presentity Xi. The network based address book may only be used for storage of the vCard data when needed.

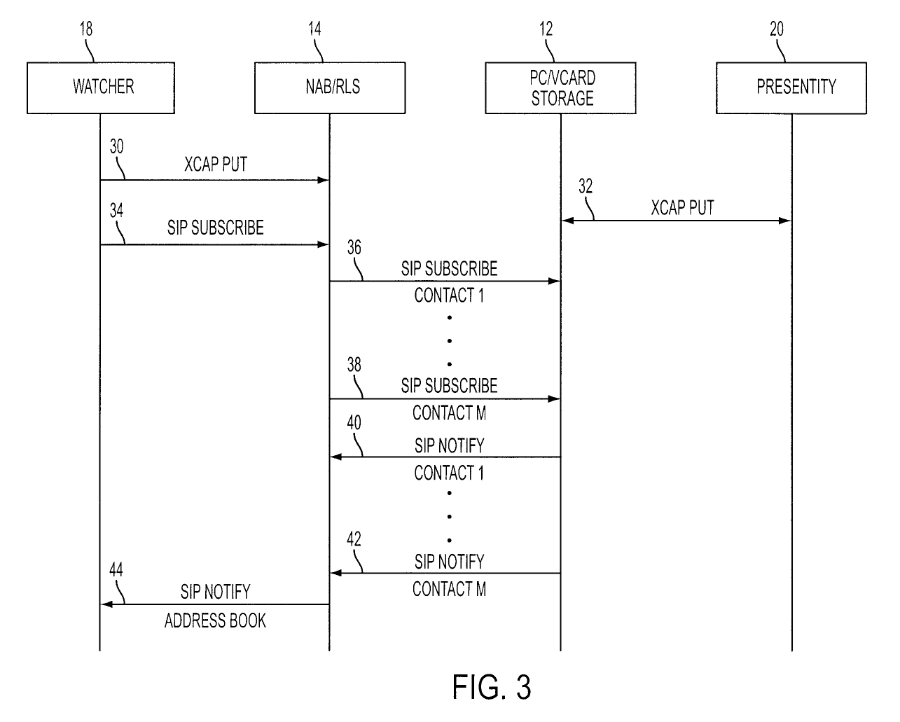

With regard to FIG. 3, a high level use of NAB 14 is described using the SIP and XCAP methods as discussed above. A watcher 18 may create his address book and may store the contact in the address book in step 30. The watcher 18 may use the XCAP PUT command to create and populate the address book. NAB and the address book storage device 14 are showed as one entity but these two services may be implemented in different devices. In step 32, the presentity 20 stores his/her personal card information in the personal card/VCard storage device 12. This storage device 12 may also store the address book of the presentity 20.

In step 34, watcher 18 may create a subscription for its address book by sending a SIP SUBSCRIBE to the NAB 14 indicating that information regarding presentity 20 is desired. This subscription may be based on a network-to-network interface that does not involve a terminal user. The network-to-network interface may be implemented in NAB 14. NAB 14 processes an identifier of the presentity 20 in the address book and sends a SIP SUBSCRIBE to the specific personal card/VCard storage server 12, for one or more contacts present in the address book. If watcher 18 has several terminals subscribing to the address book, NAB 14 may provide a single subscription for each contact.

Having received the SIP SUBSCRIBE request from watcher 18, NAB 14 contacts in steps 36 to 38 server 12 to receive information about one or more of presentities 20. Server 12 returns in steps 40 to 42 the requested information in a SIP NOTIFY to NAB 14. In another exemplary embodiment, the system may use other commands or protocols instead of the SIP protocol. The SIP protocol and associated commands are used here in an exemplary manner to facilitate a better understanding of the exemplary embodiments. NAB 14 sends in step 44 an aggregated (when applicable) SIP NOTIFY to watcher 18, including information about the contacts in the address book of watcher 18.

According to an exemplary embodiment, NAB 14 monitors changes in the presentity information and may inform watcher 18 about those changes. In this regard, it is possible to use a pull based solution in case the information is updated seldom and real time notifications are not needed.

According to another exemplary embodiment, the watcher has the choice to add desired personal data to the personal information received from the presentity and store this personal data, for example, in the NAB 14 or an associated storage device. Because watcher 18 may desire to store, in its address book, other data related to the presentity, which is not received from the personal card server 12, NAB 14 may be configured to act as a storage device for personal card data of the presentity 20. In one embodiment, NAB 14 may store this supplemental data added by watcher 18 in regard to presentity 20 but not the personal information of presentity 20 provided by server 12. This is achieved by adding data to the address book for the specific contact (presentity). NAB 14 may then aggregate this personal data together with the personal information received from the personal card server 12 when notifying watcher 18 about the received personal information of presentity 20.

According to another exemplary embodiment, NAB 14 may be configured such that watcher 18 may recover personal card data (of the presentity) when the watcher is blocked by the presentity to receive that data. In this case, in which the presentity blocks the watcher, the personal card data can no longer be retrieved by NAB 14 from server 12 on behalf of watcher 18. In other cases, this is the desired behavior of NAB 14. However, in some other cases, the watcher needs to recover the personal card data of the presentity, to which the watcher has previously had access.

According to this exemplary embodiment, the end-user terminal remembers the address book and the personal card information received from various presentities. Thus, for example, the personal card information received from the end user's presentities is available in the end-users equipment and may be recovered. This data may be saved in a storing device that may be shared by different devices of the same user. The end-user terminal may simply store this data as personal data about the contact that has denied access to its data. Optionally, the watcher may instruct the NAB to store the personal information from the presentity only when the personal information is received by the NAB from the watcher and not when received from the presentity.

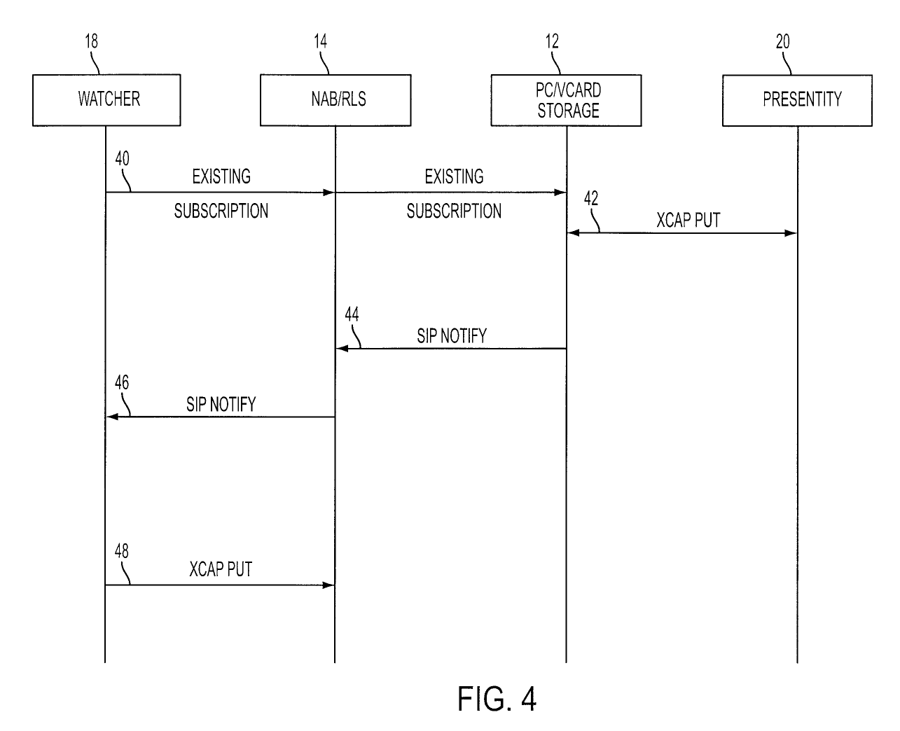

Steps associated with this exemplary embodiment for recovering the personal card data when the watcher is blocked are shown in FIG. 4. FIG. 4 shows that a subscription of watcher 18 to server 12 provided by NAB 14 exists and the subscription is set up in step 40. Presentity 20 may decide, at any time, to block watcher 18 from accessing any or part of the data related to presentity 20. Based on this decision, presentity 20 sends in step 42 an XCAP PUT command to server 12 to inform the server 12 about blocking watcher 18.

Server 12 informs in step 44 the NAB 14 about the decision of presentity 20 and terminates the existing subscription of NAB 14 to the presentity by sending a notification to NAB 14 stating that the subscription has been terminated. NAB 14 sends in step 46 a SIP NOTIFY command informing watcher 18 that presentity 20 has blocked him. Assuming that watcher 18 has locally stored data regarding presentity 20, watcher 18 may decide to store this data in NAB 14. Thus, watcher 18 may send in step 48 an XCAP PUT command to NAB 14 to store the local data, which is relevant to presentity 20.

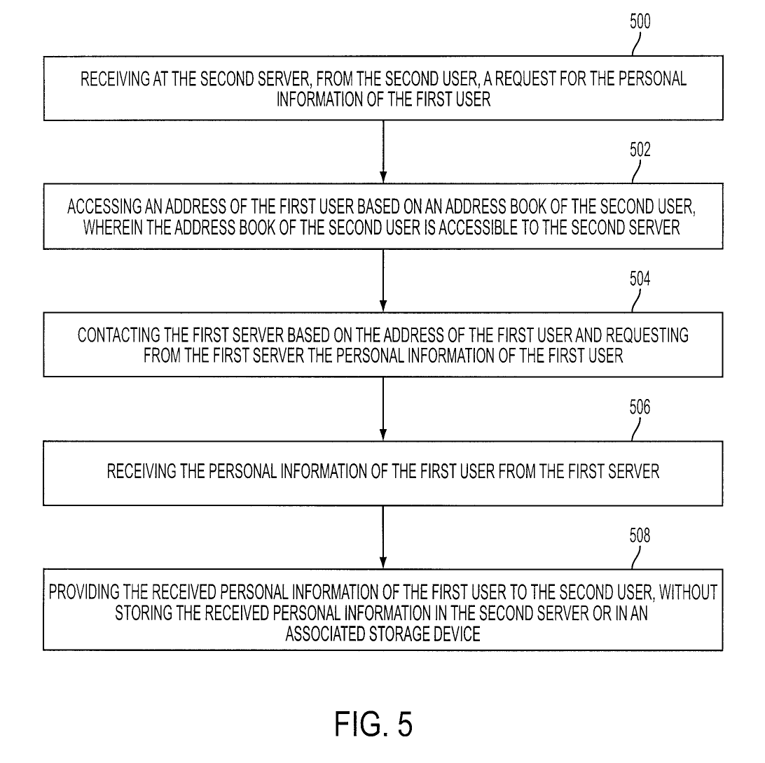

According to an exemplary embodiment shown in FIG. 5, there is a method for receiving personal information about a first user (presentity for example) and providing the personal information to a second user (watcher for example), in which the first and second users are connected to corresponding first and second servers (vCard server 12 and NAB server 14, for example) in a communication network. The method includes receiving in step 500, at the second server, from the second user, a request for the personal information of the first user, accessing in step 502 an address of the first user based on an address book of the second user, where the address book of the second user is accessible to the second server, contacting in step 504 the first server based on the address of the first user and requesting from the first server the personal information of the first user, receiving in step 506 the personal information of the first user from the first server, and providing in step 508 the received personal information of the first user to the second user, without storing the received personal information in the second server or in an associated storage device.

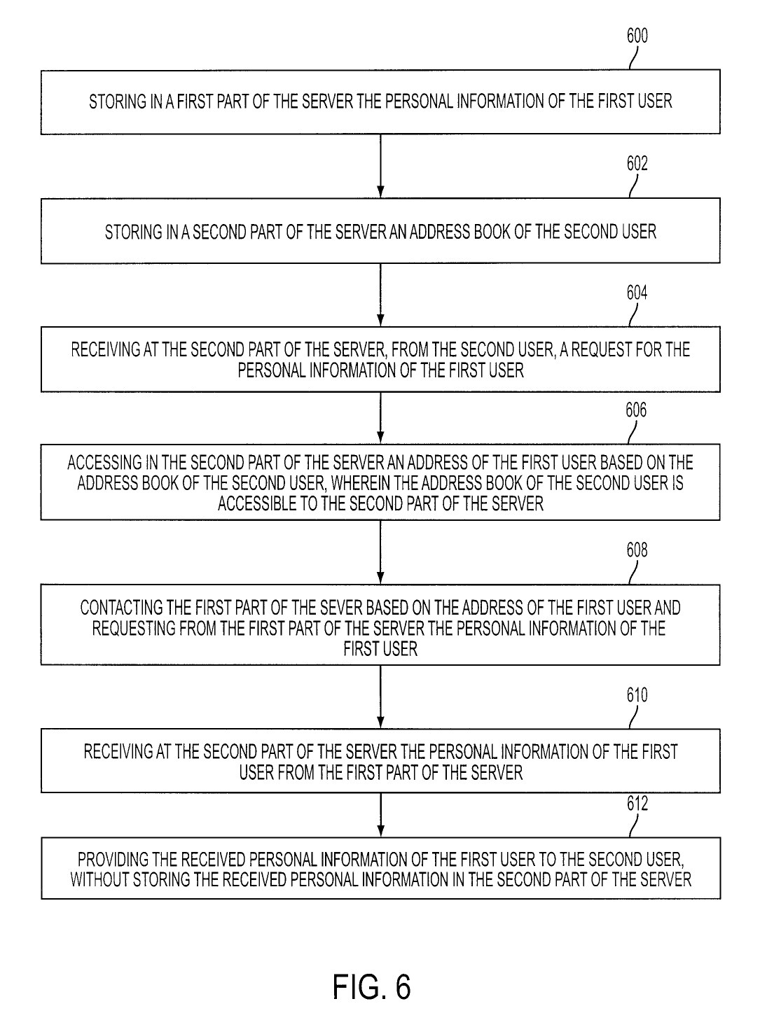

According to another exemplary embodiment shown in FIG. 6, there is a method for fetching personal information about a first user and providing the personal information to a second user, where the first and second users are connected to a server in a communication network. The method includes storing in step 600, in a first part of the server the personal information of the first user, storing in step 602, in a second part of the server an address book of the second user, receiving in step 604, at the second part of the server, from the second user, a request for the personal information of the first user, accessing in step 606, in the second part of the server an address of the first user based on the address book of the second user, wherein the address book of the second user is accessible to the second part of the server, contacting in step 608 the first part of the server based on the address of the first user and requesting from the first part of the server the personal information of the first user, receiving in step 610, at the second part of the server the personal information of the first user from the first part of the server, and providing in step 612 the received personal information of the first user to the second user, without storing the received personal information in the second part of the server.

Accordingly, one or more of the exemplary embodiments advantageously achieves a size reduction of the network address book and avoids duplication of personal card data in the network. In addition, the NAB offers the advantage of creating only one subscription for all address book contacts and/or to acting as an exploder towards each personal card server on behalf of the user (watcher). Further, the RLS functionality for presence may be implemented in the discussed system for the address book subscriptions.

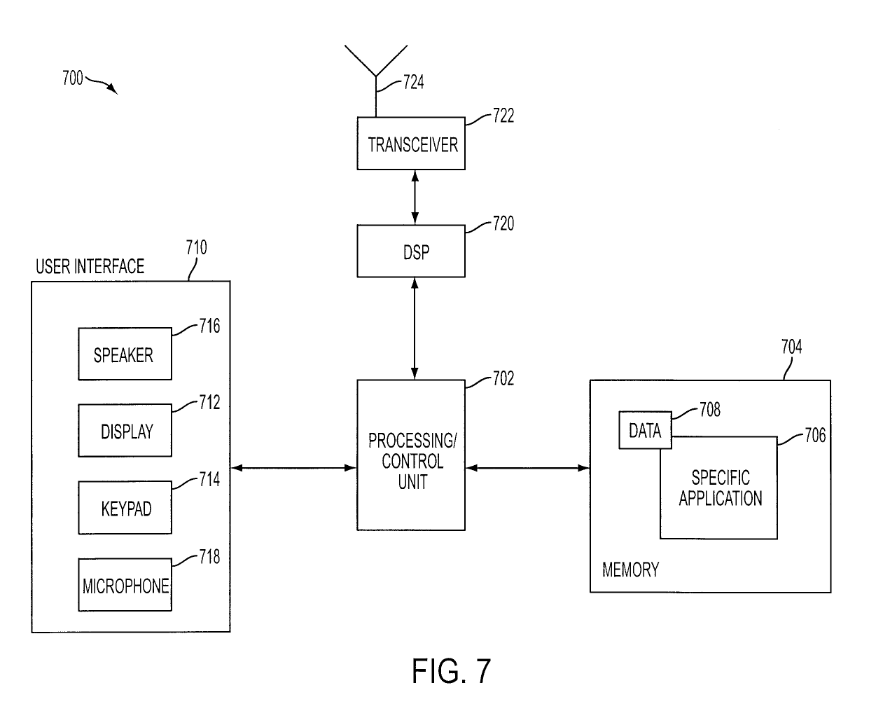

For purposes of illustration and not of limitation, an example of a representative mobile terminal computing system capable of carrying out operations in accordance with the exemplary embodiments is illustrated in FIG. 7. It should be recognized, however, that the principles of the present exemplary embodiments are equally applicable to standard computing systems.

The exemplary mobile computing arrangement 700 may include a processing/control unit 702, such as a microprocessor, reduced instruction set computer (RISC), or other central processing module. The processing unit 702 need not be a single device, and may include one or more processors. For example, the processing unit 702 may include a master processor and associated slave processors coupled to communicate with the master processor.

The processing unit 702 may control the basic functions of the mobile terminal as dictated by programs available in the storage/memory 704. Thus, the processing unit 702 may execute the functions described in FIGS. 2 and 3. More particularly, the storage/memory 704 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the mobile computing arrangement 700 via data signals, such as being downloaded electronically via a network, such as the Internet.

One of the programs that may be stored in the storage/memory 704 is a specific program 706. As previously described, the specific program 706 may interact with a location server and/or a presence server to fetch and/or subscribe to presence information of one or more presentities. The program 706 and associated features may be implemented in software and/or firmware operable by way of the processor 702. The program storage/memory 704 may also be used to store data 708, such as the various authentication rules, or other data associated with the present exemplary embodiments. In one exemplary embodiment, the programs 706 and data 708 are stored in non-volatile electrically-erasable, programmable ROM (EEPROM), flash ROM, etc. so that the information is not lost upon power down of the mobile terminal 700.

The processor 702 may also be coupled to user interface 710 elements associated with the mobile terminal. The user interface 710 of the mobile terminal may include, for example, a display 712 such as a liquid crystal display, a keypad 714, speaker 716, and a microphone 718. These and other user interface components are coupled to the processor 702 as is known in the art. The keypad 714 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism.

The mobile computing arrangement 700 may also include a digital signal processor (DSP) 720. The DSP 720 may perform a variety of functions, including analog-to-digital (A/D) conversion, digital-to-analog (D/A) conversion, speech coding/decoding, encryption/decryption, error detection and correction, bit stream translation, filtering, etc. The transceiver 722, generally coupled to an antenna 724, may transmit and receive the radio signals associated with a wireless device.

The mobile computing arrangement 700 of FIG. 7 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 706 and associated features, and data 708, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems.

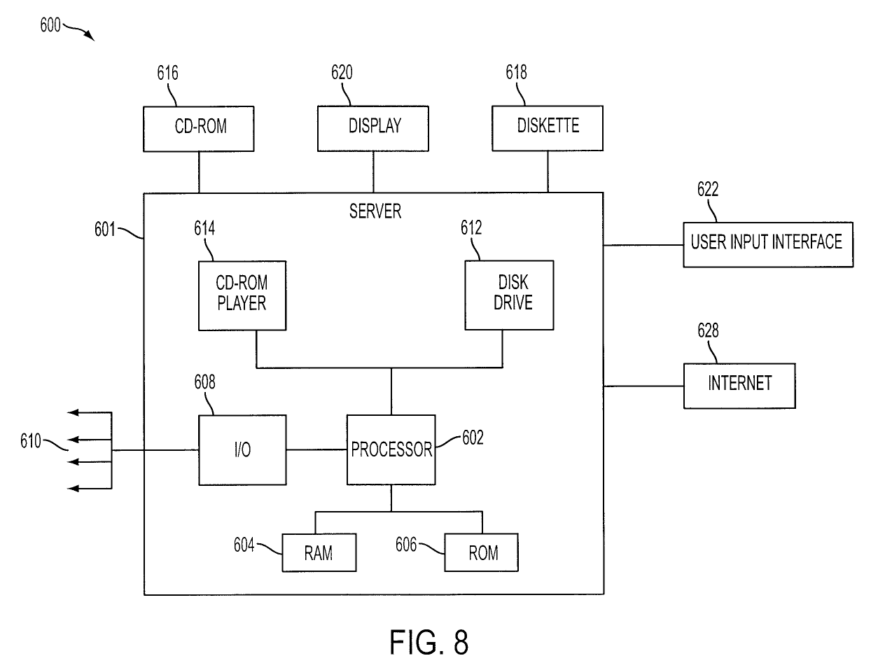

The presence, NAB, and/or vCard servers or other systems for providing personal card information and/or address information in connection with the present exemplary embodiments may be any type of computing device capable of processing and communicating presence information. An example of a representative computing system capable of carrying out operations in accordance with the servers of the exemplary embodiments is illustrated in FIG. 8. Hardware, firmware, software or a combination thereof may be used to perform the various steps and operations described herein. The computing structure 800 of FIG. 8 is an exemplary computing structure that may be used in connection with such a system.

The exemplary computing arrangement 800 suitable for performing the activities described in the exemplary embodiments may include server 801, which may correspond to any of servers 10 or 14 shown in FIG. 2. Such a server 801 may include a central processor (CPU) 802 coupled to a random access memory (RAM) 804 and to a read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. The processor 802 carries out a variety of functions as is known in the art, as dictated by software and/or firmware instructions.

The server 801 may also include one or more data storage devices, including hard and floppy disk drives 812, CD-ROM drives 814, and other hardware capable of reading and/or storing information such as DVD, etc. In one embodiment, software for carrying out the above discussed steps may be stored and distributed on a CD-ROM 816, diskette 818 or other form of media capable of portably storing information. These storage media may be inserted into, and read by, devices such as the CD-ROM drive 814, the disk drive 812, etc. The server 801 may be coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The server 801 may be coupled to other computing devices, such as the landline and/or wireless terminals and associated watcher applications, via a network. The server may be part of a larger network configuration as in a global area network (GAN) such as the Internet 828, which allows ultimate connection to the various landline and/or mobile client/watcher devices.

The disclosed exemplary embodiments provide a user terminal, a server, a system, a method and a computer program product for providing a network based address book that does not have to store personal card information. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

What is claimed is:

1. A method for receiving personal information about a first user and providing the personal information to a second user, wherein the first and second users are connected to corresponding first and second servers in a communication network, the method comprising:
receiving at the second server, from the second user, a request for the personal information of the first user;
accessing an address of the first user based on an address book of the second user, wherein the address book of the second user is accessible to the second server;
contacting the first server based on the address of the first user and requesting from the first server the personal information of the first user;
receiving the personal information of the first user from the first server; and
providing the received personal information of the first user to the second user, without storing the received personal information in the second server or in an associated storage device.

2. The method of claim 1, further comprising:
storing the address book of the second user in the second server or in the associated storage device.

3. The method of claim 1, wherein the contacting step further comprises:
subscribing via a network to network interface to the personal information of the first user.

4. The method of claim 1, further comprising:
configuring the second server to not store the personal information of the first user when received from the first server.

5. The method of claim 1, further comprising:
instructing the second server, by the second user, to store the personal information of the first user when received from the second user.

6. The method of claim 1, further comprising:
storing at the second server personal data regarding the first user and generated by the second user; and
aggregating the received personal information of the first user with the personal data generated by the second user about the first user and providing aggregated data to the second user.

7. The method of claim 1, further comprising:
storing, at the second server, the previously received personal information of the first user when the first server informs the second server that the first user has blocked access of the second user to information of the first user.

8. A receiving server for receiving personal information about a presentity and providing the personal information to a watcher, wherein the presentity and the watcher are connected to the receiving server and a sending server in a communication network, the receiving server comprising:
a receiving port configured to receive from the watcher a request for the personal information of the presentity;
a processor connected to the receiving port and configured to access an address of the presentity based on an address book of the watcher, wherein the address book of the watcher is accessible to the receiving server, configured to contact the sending server based on the address of the presentity and to request from the sending server the personal information of the presentity;
the receiving port being further configured to receive the personal information of the presentity from the sending server; and
the processor being further configured to provide the received personal information of the presentity to the watcher, without storing the received personal information.

9. The receiving server of claim 8, further comprising:
a storage device configured to store the address book of the watcher.

10. The receiving server of claim 8, wherein the storage device is configured to store personal data regarding the presentity and generated by the watcher, and the processor is further configured to aggregate the received personal information of the presentity with the personal data generated by the watcher about the presentity and providing aggregated data to the watcher.

11. The receiving server of claim 8, wherein the processor is further configured to instruct the storing device to store previously received personal information of the presentity when the sending server informs the receiving server that the presentity has blocked access of the watcher to information of the presentity.

12. A computer readable medium including computer executable instructions, wherein the instructions, when executed by a processor of a receiving server, cause the receiving server to receive personal information about a presentity and provides the personal information to a watcher, wherein the presentity and the watcher are connected to corresponding serving and receiving servers in a communication network, the instructions comprising:
receiving at the receiving server, from the watcher, a request for the personal information of the presentity;
accessing an address of the presentity based on an address book of the watcher, wherein the address book of the watcher is accessible to the receiving server;
contacting the sending server based on the address of the presentity and requesting from the sending server the personal information of the presentity;
receiving the personal information of the presentity from the sending server; and
providing the received personal information of the presentity to the watcher, without storing the received personal information in the receiving server or in an associated storage device.

13. The medium of claim 12, further comprising:
storing the address book of the watcher in the receiving server or in the associated storage device.

14. The medium of claim 12, wherein the contacting step further comprises:
subscribing via a network to network interface to the personal information of the presentity.

15. The medium of claim 12, further comprising:
configuring the receiving server to not store the personal information of the presentity when received from the sending server.

16. The medium of claim 12, further comprising:
instructing the receiving server, by the watcher, to store the personal information of the presentity when received from the watcher.

17. The medium of claim 12, further comprising:
storing at the receiving server personal data regarding the presentity and generated by the watcher; and
aggregating the received personal information of the presentity with the personal data generated by the watcher about the presentity and providing aggregated data to the watcher.

18. The medium of claim 12, further comprising:
storing, at the receiving server, the previously received personal information of the presentity when the sending server informs the receiving server that the presentity has blocked access of the watcher to information of the presentity.

19. A method for fetching personal information about a first user and providing the personal information to a second user, wherein the first and second users are connected to a server in a communication network, the method comprising:
storing in a first part of the server the personal information of the first user;
storing in a second part of the server an address book of the second user;
receiving at the second part of the server, from the second user, a request for the personal information of the first user;
accessing in the second part of the server an address of the first user based on the address book of the second user, wherein the address book of the second user is accessible to the second part of the server;
contacting the first part of the server based on the address of the first user and requesting from the first part of the server the personal information of the first user;
receiving at the second part of the server the personal information of the first user from the first part of the server; and
providing the received personal information of the first user to the second user, without storing the received personal information in the second part of the server.

20. The method of claim 19, wherein the contacting step further comprises:
subscribing via a network to network interface to the personal information of the first user.

21. The method of claim 19, further comprising:
configuring the second part of the server to not store the personal information of the first user when received from the first part of the server.

22. The method of claim 19, further comprising:
instructing the second part of the server, by the second user, to store the personal information of the first user when received from the second user.

23. The method of claim 19, further comprising:
storing at the second part of the server personal data regarding the first user and generated by the second user; and
aggregating at the second part of the server the received personal information of the first user with the personal data generated by the second user about the first user and providing aggregated data to the second user.

24. The method of claim 19, further comprising:
storing, at the second part of the server, the previously received personal information of the first user when the first part of the server informs the second part of the server that the first user has blocked access of the second user to information of the first user.

25. A server for fetching personal information about a first user and providing the personal information to a second user, wherein the first and second users are connected to the server in a communication network, the server comprising:
a first storage device in a first part of the server configured to store the personal information of the first user;
a second storage device in a second part of the server configured to store an address book of the second user;
a receiving port connected to the first and second parts of the server and configured to receive from the second user, a request for the personal information of the first user;
a processor in the second part of the server connected to the receiving port and configured to access an address of the first user based on the address book of the second user, wherein the address book of the second user is accessible to the processor and to request from a processor of the first part of the server the personal information of the first user;
the processor of the first part of the server providing to the processor of the second part of the server the personal information of the first user; and
the processor of the second part of the server providing the received personal information of the first user to the second user, without storing the received personal information in the second storage device.

26. The server of claim 25, wherein the first part of the server is a network based address book server and the second part of the server is a personal card information server.
